(19) United States
(12) Patent Application Publication
(10) Pub. No.: US 2025/0207682 A1
(43) Pub. Date: Jun. 26, 2025

(54) Emission Control Apparatus for a Control Valve

(71) Applicants: Brian Runyan, Woodward, OK (US); Matt Harper, Edmond, OK (US)

(72) Inventors: Brian Runyan, Woodward, OK (US); Matt Harper, Edmond, OK (US)

(21) Appl. No.: 18/394,842

(22) Filed: Dec. 22, 2023

(51) Int. Cl. F16K 31/128; E21B 34/00

(52) U.S. Cl. CPC F16K 31/1262; E21B 34/00

(57) ABSTRACT

The present invention is directed to an apparatus that satisfies the need for a closed system to actuate the control valve for zero-emissions control—not bleeding natural gas into the atmosphere. In one aspect, the apparatus includes a linear actuator, a power supply, a fluid power cylinder, and a supply line. In another aspect, the apparatus further includes a programmable logic controller. The power supply provides a power source for the linear actuator and programmable logic controller. The programmable logic controller delivers an output signal to the linear actuator. The linear actuator includes a piston that compresses or decompresses the volume within the fluid power cylinder. The piston is actuated to create a desired output pressure. The supply line delivers the desired output pressure from the fluid power cylinder to the control valve. The desired output pressure regulates pressurized fluid flow within the control valve.

### CROSS-REFERENCE TO RELATED APPLICATIONS

This application claims the benefit of U.S. Provisional Patent Application No. 63/476,922, filed Jul. 1, 2018, which is incorporated by reference herein in its entirety.

### BACKGROUND

This section is intended to introduce the reader to various aspects of art that may be related to various aspects of the presently described embodiments. This discussion is believed to provide the reader with background information to facilitate a better understanding of the various aspects of the present embodiments. Accordingly, it should be understood that these statements are to be read in this light and not as admissions of prior art.

The field of the invention generally relates to oil and gas. In particular, the invention relates to flow control devices, such as pneumatic control valves, in the oil and gas field.

Modern oil and gas well sites require various production facility equipment for efficient oil and gas flow. Equipment for an extraction site can include horizontal and vertical separators, line heats, free water knock-outs, compressors, and more. As technology has improved and the number of wells drilled has increased, many extraction sites require automated systems or the ability to control the equipment remotely.

Dynamic control valves are used on various oil and gas equipment to allow the flow to be wholly or partially restricted based on a reading off the line, such as a liquid level indicator. Traditionally, a well site attendant would need to continually visit the well location to turn the valves based on the readings. Now, dynamic control valves handle this automatically. These dynamic control valves can be used to regulate pressure or flow, serve as a dump control valve for flowback, or be used for plunger lift operations.

While there are several types of dynamic control valves, there are two main types: cage-guided and stem-guided. Traditionally, these control valves are controlled using well gas or buy-back gas. FIG. 1-FIG. 3 illustrate the general cooperation of a tank supplying buy-back gas for regulating flow within a control valve. A pneumatic signal is sent to an actuator operating the control valve. Buy-back gas is used to lift or lower the diaphragm assembly within a bonnet of the control valve, allowing the stem or gate to change position. The volume amount entering the bonnet allows for trim options.

In most applications, buy-back gas intermittently vents into the atmosphere when the control valve returns to its previous position. The amount of gas emitted depends on the amount the control valve is actuated. By emitting the buy-back gas into the atmosphere, well sites continuously pollute the air. Therefore, there is a need for a reduced-emission control system to minimize pollution.

Current art includes solutions for zero-emission actuators, but it is well known to one skilled in the art that these solutions have shortcomings. Adapters such as rotary actuators and linear actuators can be installed on a control valve. The rotary actuators translate rotary motion into linear motion. The linear actuators use a roller screw attached to a servo motor to convert the rotary motion of the motor directly to a linear force. However, approaches by current art have several disadvantages. The actuators require some modification of control valves and an additional adaptor to operate them. Current art for actuators can be time-consuming to install and costly. Therefore, it is desirable for an alternative that is easier to implement, more cost-effective and does not require substantial modification of the existing control valve.

FIG. 5 is a linear actuator that has been known for many decades. See, for example, U.S. Pat. No. 4,307,799 for a Linear Actuator issued to Zouzoulas on Dec. 29, 1981, incorporated by reference.

What is needed is an apparatus that solves the aforementioned problems.

### SUMMARY

Certain aspects of some embodiments disclosed herein are set forth below. It should be understood that these aspects are presented merely to provide the reader with a brief summary of certain forms the invention might take and that these aspects are not intended to limit the scope of the invention. Indeed, the invention may encompass various aspects that may not be set forth below.

The present invention is directed to an emissions control apparatus that satisfies this need for a closed system—not bleeding natural gas into the atmosphere to actuate the control valve for zero-emissions control. The problems of the previous systems, including implementation, complex configuration of an existing control valve, and cost, are addressed through the use of a supply line connected from an actuator to the bonnet of a control valve.

The invention satisfies the need for a zero-emission control system. The invention is a simple solution that requires minimal configuration of an existing control valve and is less costly than current art.

### BRIEF DESCRIPTION OF THE DRAWINGS

These and other features, aspects, and advantages of the present invention will become better understood with regard to the following description, appended claims, and accompanying drawings:

FIG. 1 generally depicts a system for oil and gas production;

FIG. 2 is a cross-section view of an exemplary control valve;

FIG. 3 is a side elevation view of a prior art control valve;

FIG. 4 is an elevation view of the emissions control apparatus connected to the control valve;

FIG. 5 is an elevation view of the emissions control apparatus in a decompressed position;

FIG. 6 is an elevation view of the emissions control apparatus in a partially compressed position; and

FIG. 7 is an elevation view of the emissions control apparatus in a fully compressed position.

### DESCRIPTION

One or more specific embodiments of the present disclosure will be described below. To provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

When introducing elements of various embodiments, the articles “a,” “an,” “the” and “said” are intended to mean that there are one or more of the elements. The terms “comprising,” “including,” “having,” and grammatical equivalents thereof are intended to be inclusive and mean that there may be additional elements other than the listed elements.

Moreover, any use of “top,” “bottom,” “above,” “below,” other directional terms, and variations of these terms is made for convenience, but does not require any particular orientation of the components.

The term “at least” followed by a number is used herein to denote the start of a range beginning with that number (which may be a range having an upper limit or no upper limit, depending on the variable being defined). For example, “at least 1” means 1 or more than 1.

The term “at most” followed by a number is used herein to denote the end of a range ending with that number (which may be a range having 1 or 0 as its lower limit or a range having no lower limit, depending upon the variable being defined). For example, “at most 4” means 4 or less than 4, and “at most 40% means 40% or less than 40-%.

When in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit 100 mm.

“Control valve” refers to control valves, including pressure control valves, used for flow control across a wide range of applications of the type such as Kimray stem-guided bottom works model CVS in the oil and gas production. Applications for control valves include the control valve used as a dump valve, pressure regulator, suction controller, recirculation valves, as well as in plunger lift or flowback application. Common control valves include cage guided and stem-guided control valves.

“Linear actuator” refers to an actuator that creates motion in a straight line. Linear actuators are used in machine tools and industrial machinery such as valves and dampers, and many other places where linear motion is required.

In one aspect, a emissions control apparatus for a control valve in an oil and gas extraction, the apparatus includes an actuator, a power supply, a fluid power cylinder, and a supply line. The actuator includes a piston that compresses or decompresses the volume within the fluid power cylinder. The power supply delivers power to the actuator. The fluid power cylinder defines a bore therein for cooperation with the piston. The supply line is connected from the fluid power cylinder to the control valve. The piston is actuated to create a desired output pressure. The desired output pressure is delivered from the fluid power cylinder to the control valve through the supply line. The desired output pressure is used to regulate pressurized fluid flow within the control valve.

Other aspects of the invention include an actuator, a power supply, a fluid power cylinder, a supply line, and a programmable logic controller. The actuator includes a piston that compresses or decompresses the volume within the fluid power cylinder. The power supply delivers power to the actuator and the programmable logic controller. The fluid power cylinder defines a bore therein for cooperation with the piston. The supply line is connected from the fluid power cylinder to the control valve. The programmable logic controller delivers an output signal to the actuator. The piston is actuated to create a desired output pressure. The desired output pressure is delivered from the fluid power cylinder to the control valve through the supply line. The desired output pressure is used to regulate pressurized fluid flow within the control valve.

Another aspect of the invention includes, a linear actuator, a power supply, a fluid power cylinder capable of compress and decompressing a known volume to push gas back to a sales line, thereby eliminating emissions while reducing equipment required to continue valve operations. A programmable logic controller is connected to the linear actuator. The linear actuator is attached to the fluid power cylinder. The fluid power cylinder is connected to the control valve at a bonnet. As the actuator receives a signal to close, it decreases the volume and pulls exhaust gases into the fluid power cylinder. The signal is reversed, the actuator extends thereby decreasing the volume and increasing pressure above that of the sales line. The fluid power cylinder discharges upstream of the gas meter. The compressed gas exits the fluid power cylinder and can be sold for alternate applications.

Yet another aspect of the invention includes a linear actuator, a power supply, a fluid power cylinder, a supply line, and a programmable logic controller. The linear actuator includes a piston that compresses or decompresses the volume within the fluid power cylinder. The power supply delivers power to the linear actuator and the programmable logic controller. The fluid power cylinder defines a bore therein for cooperation with the piston. The supply line is connected from the fluid power cylinder to the control valve. The programmable logic controller delivers an output signal to the linear actuator. The piston is actuated to create a desired output pressure. The desired output pressure is delivered from the fluid power cylinder to the control valve through the supply line. The desired output pressure is used to regulate pressurized fluid flow within the control valve.

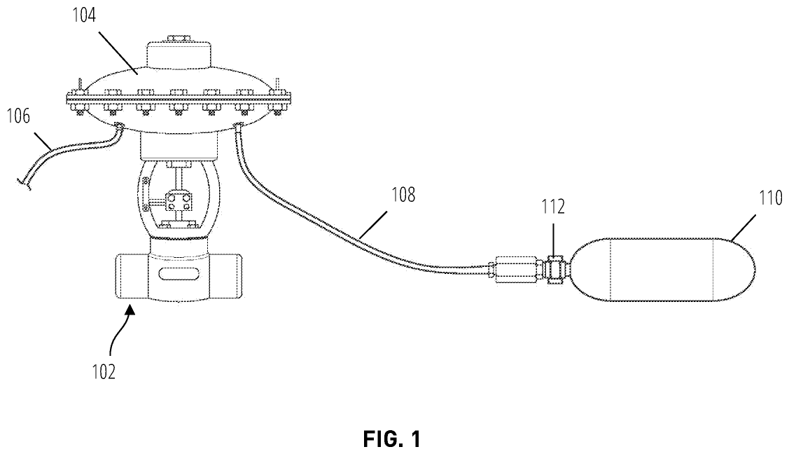

Turning to the present figures, FIG. 1-FIG. 3 generally depict current systems to control flow within an oil and gas production. FIG. 1 is a side elevation view of an exemplary control valve 102 connected to a supply line 108. The supply line 108 is connected to a solenoid valve 112, which is connected to a tank 110.

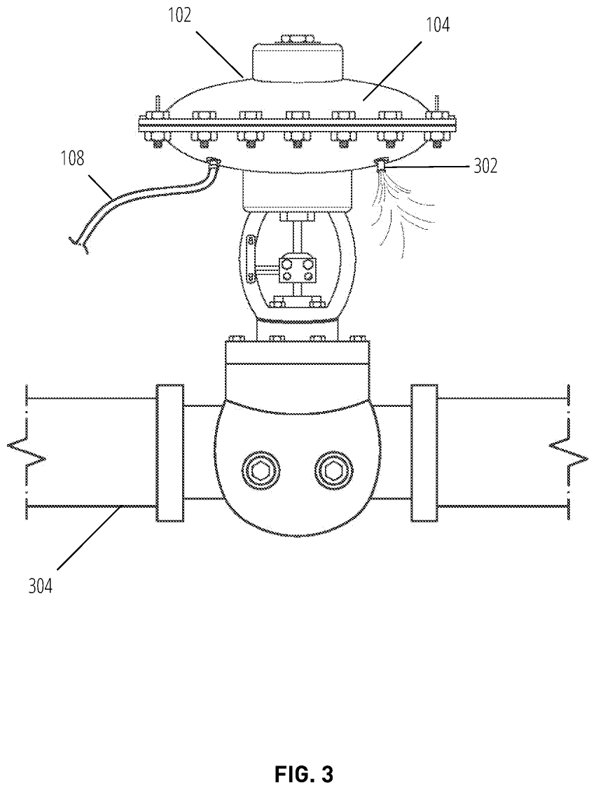

The control valve 102 of the type featured is well known to one skilled in the art. The control valve 102 regulates the flow of a pressurized fluid (see FIG. 3) in an oil and gas extraction.

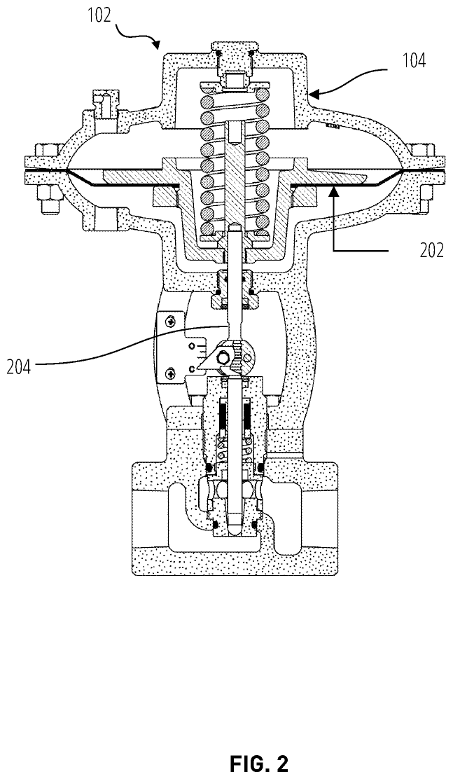

The control valve 102 has a bonnet 104. The bonnet 104 covers the opening through which the internal parts are inserted. Within the bonnet 104 is a control valve diaphragm assembly (shown in FIG. 2).

Tank 110, shown in FIG. 1, may store buyback gas. The buyback gas is used to facilitate different trim options.

A detailed view of the control valve 102 is shown in FIG. 2. As the diaphragm 202 changes position, flow is regulated by the control valve 102.

Buyback gas is used to lift or lower the diaphragm 202 within the bonnet 104 of the control valve 102, allowing the stem 204 or gate to change position. The volume amount entering the bonnet 104 allows for different trim options.

FIG. 3 depicts current systems and how emissions are released into the atmosphere. FIG. 3 is a side elevation view of a control valve 102 connected to a flow line 304. A pressurized fluid travels from a first end of a flow line 304, through the control valve 102 to a second end of the flow line 304. The pressurized fluid flows in one direction through the control valve 102 from an upstream pressure to a downstream pressure. As less pressure is required to control fluid flow, buyback gas is expelled from the bonnet 104 into the atmosphere.

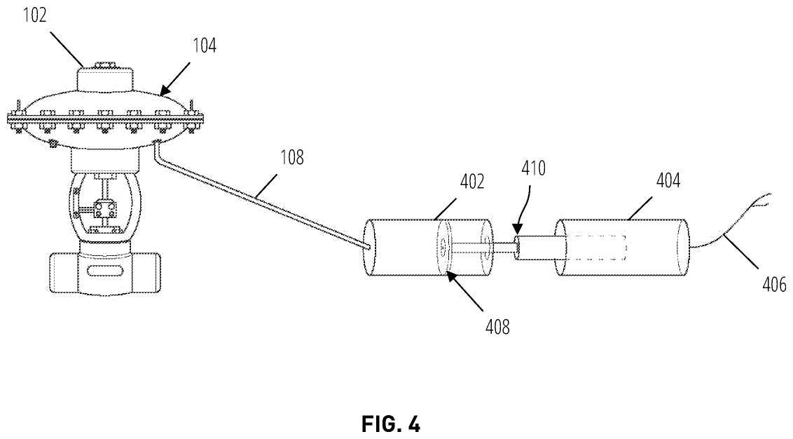

FIG. 4 generally depicts a closed feedback system for controlling the flow in oil and gas production. As shown in FIG. 4 are a control valve 102 and a emissions control apparatus 410. The emissions control apparatus 410 includes a cable 406, an actuator, a piston 408, a fluid chamber that is substantially cylindrical, such as a hydraulic cylinder 402, and a supply line 108. The actuator, as shown, is a linear actuator 404. Not shown in FIG. 4 is the programmable logic controller and power supply. The programmable logic controller is of the type well known to one skilled in the art. The power supply may be an electrical device such as a battery, solar panel, or other devices well known to one skilled in the art. A cable 406 runs from the programmable logic controller and the power supply to the linear actuator 404. The linear actuator 404 has a piston 408 at one end of the linear actuator 404 and is connected to the hydraulic cylinder 402. The hydraulic cylinder 402 is connected to the control valve 102, specifically at the bonnet 104. To close the control valve 102, a signal is sent by the programmable logic controller to the linear actuator 404 to return it to its original position. As described in greater depth, the decompression of the hydraulic cylinder 402 allows the control valve 102 to close.

Control valves 102 of the type shown commonly feature a bonnet 104. The emissions control apparatus 410, as shown, is connected directly to the bonnet 104 of the control valve 102, thus reducing the need to adapt the control valve 102 for cooperation with an actuator. The output of the hydraulic cylinder 402 is fed back into the input creating a closed feedback system. A closed system is created between the emissions control apparatus 410 and the control valve 102.

Volume changes within the hydraulic cylinder 402 are used to actuate the diaphragm 202, thereby controlling flow within the control valve 102.

It should be appreciated that other fluid power embodiments of the fluid chamber, such as a pneumatic cylinder, may be used. In some oil and gas extraction applications, a pneumatic cylinder may be preferred. Furthermore, the fluid within the fluid chamber may be air, nitrogen, natural gas, or another fluid.

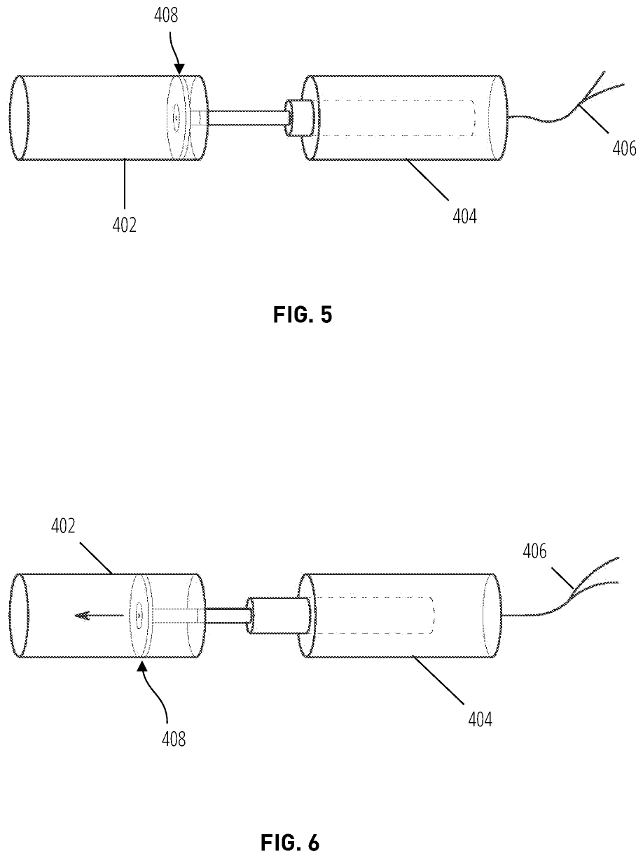

FIG. 5-FIG. 7 are detailed views of the linear actuator 404 and the hydraulic cylinder 402. FIG. 5 depicts a linear actuator 404 in cooperation with a hydraulic cylinder 402. The linear actuator 404 is connected to the piston 408. The hydraulic cylinder 402 is in a decompressed position.

When the hydraulic cylinder 402 is in a decompressed position, the volume within the hydraulic cylinder 402 is greater than the volume within the bonnet 104; thus, the diaphragm 202 is in a low position.

FIG. 6 depicts the linear actuator 404 in cooperation with a hydraulic cylinder 402 in a partially compressed position.

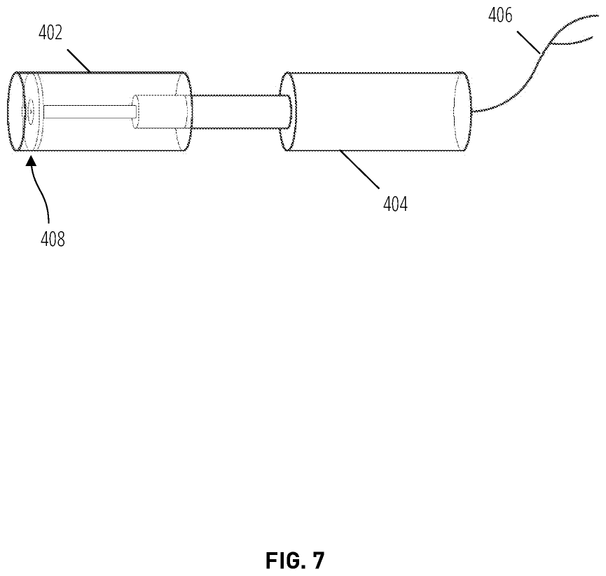

FIG. 7 depicts the linear actuator 404 in cooperation with a hydraulic cylinder 402 in a fully compressed position. When the hydraulic cylinder 402 is compressed, the volume within the hydraulic cylinder 402 is less than that within the bonnet 104. Thus, the diaphragm 202 is in a high position.

Because this is a closed feedback system, no natural gas is emitted into the atmosphere. A closed feedback system can improve efficiency and accuracy while reducing errors and deviations from desired values by continuously monitoring and adjusting the system based on feedback.

Substantial reconfiguration of an existing control valve in oil and gas extraction is a costly, time-consuming, and inefficient process. It typically involves significant downtime and interrupts the normal operation of the facility. Additionally, the reconfiguration process requires skilled technicians and specialized equipment, which can add to the overall cost of a project. Furthermore, any errors or mistakes during the reconfiguration process can result in safety hazards and operational issues. The present invention solves the need for an apparatus with the advantages of a zero-emission actuator but does not require substantial reconfiguration of an existing control valve.

Although the present invention has been described in considerable detail with reference to certain preferred versions thereof, other versions are possible. Therefore, the spirit and scope of the appended claims should not be limited to the description of the preferred versions contained herein. Any element in a claim that does not explicitly state “means for” performing a specified function or “step for” performing a specific function is not to be interpreted as a “means” or “step” clause as specified in 35 U.S.C. § 112, ¶ 6. In particular, the use of “step of” in the claims herein is not intended to invoke the provisions of 35 U.S.C. § 112, ¶ 6.

What is claimed is:

1. An emissions control apparatus for a control valve in an oil and gas extraction, the apparatus comprising:
an actuator comprising a piston at one end;
a power supply, the power supply delivering power to the actuator;
a fluid power cylinder comprising an interior surface, an external diameter, the interior surface defining a bore therein for slidingly receiving the piston; and
a supply line connecting the fluid power cylinder to the control valve;
whereby the actuator operates the piston changing the pressure within the fluid power cylinder, creating a desired output pressure thus, through the supply line, the desired output pressure controlling the pressure within the control valve to vary a flow rate.

2. The emissions control apparatus of claim 1, further comprising a programmable logic controller receiving power from the power supply.

3. The emissions control apparatus of claim 1, the programmable logic controller delivering an output signal to the actuator.

4. The emission control apparatus of claim 1, the actuator comprising electric.

5. The emissions control apparatus of claim 1, the power supply comprising a battery.

6. An emissions control apparatus for a high pressure pneumatic control valve in an oil and gas extraction, the apparatus comprising:
a linear actuator;
the linear actuator comprising a piston at one end;
a programmable logic controller;
the programmable logic controller delivering an output signal to the linear actuator;
a battery;
the battery delivering power to the linear actuator;
the battery delivering power to the programmable logic controller;
a substantially cylindrical fluid chamber defining a bore therein for cooperation with the piston; and
a supply line connected from the fluid chamber to the control valve;
whereby the linear actuator operates the piston changing the pressure within the fluid chamber creating a desired output pressure thus, through the supply line, the desired output pressure controlling the pressure within the control valve to vary a flow rate.
